(19) United States
(12) Patent Application Publication
(10) Pub. No.: US 2012/0158979 A1
(43) Pub. Date: Jun. 21, 2012

(54) METHOD AND APPARATUS FOR CONTROLLING ACCESS TO ACCESS POINT IN MOBILE TERMINAL

(75) Inventors: Jung Hun LEE, Suwon-si (KR); Bu Seop JUNG, Suwon-si (KR); Jhong Il KIM, Suwon-si (KR); Gi Beom KIM, Seoul (KR); Jong Mu CHOI, Gunpo-si (KR); Hyun Soo KIM, Yongin-si (KR); Jeong Il KWON, Seoul (KR)

(73) Assignee: SAMSUNG ELECTRONICS CO. LTD., Suwon-si (KR)

(21) Appl. No.: 13/328,197

(22) Filed: Dec. 16, 2011

(30) Foreign Application Priority Data
Dec. 17, 2010 (KR) 10-2010-0129835

(51) Int. Cl. G06F 15/16

(52) U.S. Cl. 709/229

(57) ABSTRACT

A method and an apparatus for controlling access to an Access Point AP in a mobile terminal are provided. The method includes storing information of an AP as profile information, determining whether profile information of an accessed AP is stored in the mobile terminal when the mobile terminal accesses the AP, and logging in to the accessed AP based on the stored profile information.

### PRIORITY

This application claims the under 35 U.S.C. §119(a) of a Korean patent application filed on Dec. 17, 2010 in the Korean Intellectual Property Office and assigned Serial No. 10-2010-0129835, the entire disclosure of which is hereby incorporated by reference.

### BACKGROUND OF THE INVENTION

1. Field of the Invention

The present invention relates to a method and an apparatus for controlling access to an Access Point (AP) in a mobile terminal More particularly, the present invention relates to a method and an apparatus for controlling access to an AP in a mobile terminal capable of improving convenience for a user and an apparatus implementing the same.

2. Description of the Related Art

In recent years, with increased use of Wi-Fi, hotspots supporting Internet through Wi-Fi are increasing. A hotspot is a public place in which an Access Point (AP) functioning as a base station is installed such that many persons may access the Internet through a wireless Local Area Network (LAN).

Because a plurality of unknown users use a hotspot AP, security is essential. A user should be authenticated from a corresponding service provider to access the Internet in the hotspot.

After accessing a hotspot AP, a user executes a browser to receive a redirect message. If a credential for authentication is input, the user is authenticated from a service provider. However, since authentication procedures vary between service providers, the user repeatedly performs the foregoing procedures every time to access the Internet in the hotspot. In this case, because the user inputs credentials every time, the user may feel inconvenienced. It takes a long time between the time a hotspot AP is first accessed until an environment in which the Internet is capable of being used is established.

Further, when a user terminal accesses an AP, the user may determine whether a currently accessed AP is an Internet accessible AP when the user executes a browser. If the user terminal accesses an AP through which the Internet cannot be accessed, the user needs to access another AP and repeatedly executing a browser to search for an AP through which the Internet can be accessed. Such an operation may annoy the users.

### SUMMARY OF THE INVENTION

Aspects of the present invention are to address at least the above-mentioned problems and/or disadvantages and to provide at least the advantages described below. Accordingly, an aspect of the present invention is to provide a method for controlling access to an Access Point (AP) in a mobile terminal that may improve an authentication procedure for using Internet to enhance convenience for a user, and an apparatus implementing the same.

Another aspect of the present invention is to provide a method for controlling access to an AP in a mobile terminal that provides information regarding whether a currently accessed AP is an AP through which the Internet can be accessed to improve convenience for a user, and an apparatus implementing the same.

In accordance with an aspect of the present invention, a method for controlling access to an AP in a mobile terminal is provided. The method includes storing information of an AP as profile information, determining whether profile information of an accessed AP is stored in the mobile terminal when the mobile terminal accesses the AP, and logging in to the accessed AP based on the stored profile information.

In accordance with another aspect of the present invention, a mobile terminal is provided. The terminal includes a memory for storing profile information of at least one access point (AP), a near distance communication module for accessing an AP, and a controller determining whether the profile information of the accessed AP is stored in the memory, and for logging in to the accessed AP based on the stored profile information when the profile information of the accessed AP is stored in the memory.

In a case where a user terminal accesses a hotspot AP, if it is not a first access, aspects of the present invention automatically perform an authentication procedure with a service provider using stored profile information. Accordingly, the user need not input a credential every time. As a result, an amount of time taken between accessing a hotspot AP and establishing an environment in which the Internet can be accessed may be reduced.

Further, when the user terminal accesses an AP, aspects of the present invention provide information regarding whether or not a currently accessed AP is an Internet accessible AP or based on stored profile information. Accordingly, the user may recognize whether the currently accessed AP is an Internet usable AP without execution of a browser.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of an Internet service system according to an exemplary embodiment of the present invention;

FIG. 2 is a block diagram illustrating a configuration of a mobile terminal according to an exemplary embodiment of the present invention;

FIG. 3A and FIG. 3B are a flowchart illustrating a method for controlling access to an Access Point (AP) in a mobile terminal according to an exemplary embodiment of the present invention;

FIG. 4 is a flowchart illustrating a detailed procedure of step 305 shown in FIG. 3A according to an exemplary embodiment of the present invention;

FIG. 5 is a flowchart illustrating a detailed procedure of step 308 shown in FIG. 3B according to an exemplary embodiment of the present invention;

FIG. 6 is a flowchart illustrating a detailed procedure of step 305 shown in FIG. 3A according to an exemplary embodiment of the present invention; and

FIGS. 7A and 7B are views illustrating examples of a screen displayed when performing a method for controlling access to an AP in a mobile terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the term “public AP” denotes a hotspot Access Point (AP) installed at a public place, and refers to an AP that requires a login procedure to use the Internet. The term “general AP” denotes an AP other than the public AP, and refers to an AP that does not require a login procedure to use the Internet. The term “login procedure” denotes an authentication procedure executed to use the Internet after accessing the public AP.

As used herein, the term “profile information” denotes information regarding a previously accessed AP. According to exemplary embodiments of the present invention, the profile information is stored and managed in a mobile terminal, and may contain an ‘MAC address’, ‘Internet availability’, a ‘credential’, and a ‘service limit condition’. The profile information may include ‘redirect message storage path’ as well as the foregoing information.

The ‘credential’ denotes unique user information used for a login procedure to the AP, and may be composed of a user Identifier (ID) and a password.

The ‘service limit condition’ denotes a limit condition when using a public AP, and may be a time limit condition or a data capacity limit condition.

The ‘redirect message’ denotes a message provided for credential input when logging in to the public AP.

The mobile terminal according to an exemplary embodiment of the present invention is a terminal including a near distance communication module. The mobile terminal may be configured by an information communication device and a multimedia device such as a Portable Multimedia Player (PMP), a Personal Digital Assistant (PDA), a Smart Phone, or a music player.

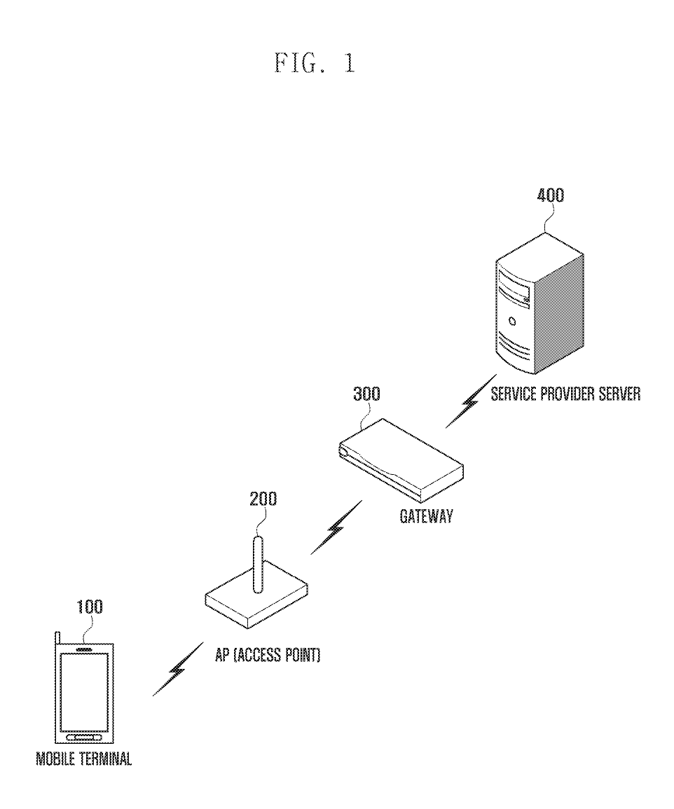

FIG. 1 is a block diagram illustrating a configuration of an Internet service system according to an exemplary embodiment of the present invention.

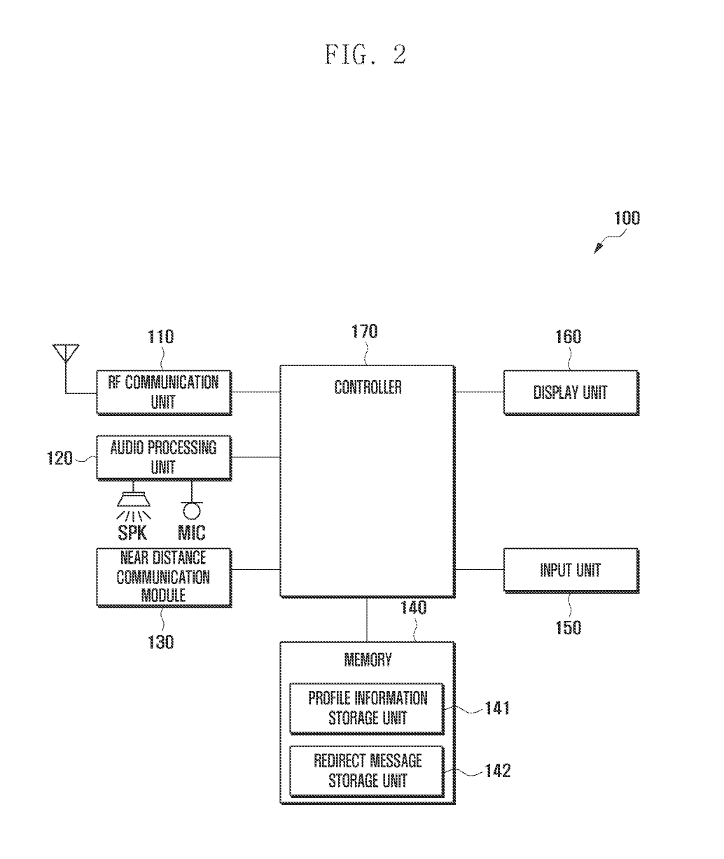

Referring to FIG. 1, the mobile terminal 100 is a device carried by a user. The mobile terminal 100 includes a near distance communication module accessing an AP 200. The mobile terminal is described below with reference to FIG. 2.

The AP 200 refers to a base station supporting wireless access and network connection of the mobile terminal 100. The AP 200 accesses the mobile terminal 100, and transmits a signal received from the mobile terminal 100 to a gateway 300. The AP 200 transmits a signal received from the gateway 300 to the mobile terminal 100. The AP 200 may be a hotspot AP or a general AP.

The gateway 300 is a structural element corresponding to a middle manager between the AP 200 and a service provider 400. If the gateway 300 receives a HyperText Transfer Protocol (HTTP) request created by the mobile terminal 100, the gateway 300 transmits a redirect message to the AP 200. If the gateway 300 receives a message including a credential of a user from the AP 200, the gateway 300 transmits an Authentication request to a service provider server 400. If the gateway 300 receives the Authentication request from the service provider server 400, the gateway 300 transmits a login Success Notification to the AP 200. The gateway 300 transmits a billing Start Accounting message to the service provider server 400, and receives an Acknowledgment from the service provider server 400.

If the gateway 300 receives a logoff request from the AP 200, the gateway 300 transmits a Stop Accounting message to the service provider server 400. If the gateway receives an Acknowledgment from the service provider server 400, the gateway 300 transmits a Logoff Notification to the AP 200.

The service provider server 400 manages an Internet service through the AP 200, and controls login, Authentication, logoff, and accounting of the mobile terminal 100. The service provider server 400 communicates with the mobile terminal 100 through the AP 200 and the gateway 300. If the service provider server 400 receives an authentication request including a credential of a user from the gateway 300, the service provider server 400 performs an authentication procedure of a user using the credential. When it is determined that the user of the mobile terminal 100 is an authenticated user, the service provider server 400 transmits an authentication response including accept information to the gateway 300. When it is determined that the user of the mobile terminal 100 is not the authenticated user, the service provider server 400 transmits an authentication response including a deny information to the gateway 300.

If the service provider server 400 receives a counting start message from the gateway 300, the service provider server 400 transmits an acknowledgement to the gateway 300 and starts accounting with respect to use of the Internet by the mobile terminal 100. If the service provider server 400 receives a stop accounting message from the gateway 300, the service provider server 400 transmits an acknowledgement to the gateway 300, and stops accounting of use of the Internet by the mobile terminal 100.

FIG. 2 is a block diagram illustrating a configuration of a mobile terminal according to an exemplary embodiment of the present invention.

Referring to FIG. 2, the RF communication unit 110 performs transmitting and receiving functions of corresponding data for Radio Frequency (RF) communication. The RF communication unit 110 may include a transmitter (not shown) up-converting a frequency of a transmission signal and amplifying the transmission signal, a receiver (not shown) low-noise-amplifying a received signal and down-converting the received signal. The RF communication unit 110 receives data through an RF channel and outputs the received data to the controller 170. The RF communication unit 110 may transmit data output from the controller 170 through the RF channel.

The audio processing unit 120 may be configured by a codec. The codec may include a data codec processing packet data and an audio codec processing an audio signal. The audio processing unit 120 converts a digital audio signal into an analog audio signal using the audio codec, and plays the analog audio signal using a speaker SPK. The audio processing unit 120 converts an analog audio signal input from a microphone MIC into a digital audio signal using the audio codec.

A near distance communication module 130 transmits and receives an RF signal to and from the AP 200. The near distance communication module 130 may be configured by a Wi-Fi communication module. The near distance communication module 130 may also be configured as a Bluetooth communication module, a Zigbee communication module, a Radio Frequency Identification (RFID) module, or the like. The near distance communication module 130 scans entire channels, transmits a probe request to the AP 200, and receives a probe response from the AP 200. This enables the mobile terminal 100 to identify the AP 200. When the user requests a connection to the AP 200, the near distance communication module 130 transmits an association request to the AP 200, and receives an association response from the AP 200. As a result, the mobile terminal 100 may access the AP 200.

The near distance communication module 130 transmits an HTTP request to the AP 200 while the mobile terminal 100 is connected to the AP 200, and receives a redirect message from the AP 200. The near distance communication module 130 transmits an authentication request message created by the controller 170 to the AP 200, and receives a login Success Notification from the AP 200.

The memory 140 stores programs and data necessary for an operation of the mobile terminal 100. The memory 140 may be divided into a program area and a data area. The program area may store a program controlling an overall operation of the mobile terminal 100, an Operating System (OS) booting the mobile terminal 100, an application program necessary for playback of multimedia contents, or other optional functions of the mobile terminal, such as a camera function, a sound playing function, or an image or moving image playing function. The data area stores data created according to use of the mobile terminal 100, for example, images, moving images, phone books, and audio data.

The memory 140 includes a profile information storage unit 141 and a redirect message storage unit 142. The profile information storage unit 141 stores profile information which is information regarding a previously accessed AP. The profile information may contain a ‘Media Access Control (MAC) address’, ‘Internet availability’, a ‘credential’, and a ‘service limit condition’. The ‘Internet availability’ denotes information indicating whether the AP 200 is connected to the Internet. The ‘credential’ denotes unique information of a user used for a login procedure to the AP 200, and may include a user ID and a password. The ‘service limit condition’ may be a limit condition when using the AP 200, which is a time limit condition or a data capacity limit condition. According to an exemplary embodiment of the present invention, the profile information may include a Service Set Identifier (SSID), which is a unique identification of the service provider server 400, and a Basic Service Set Identifier (BSSID), which is a unique identification of the AP 200. The profile information may further include a ‘redirect message storing path’ except for the ‘MAC address’, the ‘Internet availability’, the ‘credential’, and the ‘service limit condition’.

The redirect message storage unit 142 stores a redirect message from the AP 200. When logging in to a public AP, the redirect message is a message provided for credential input. The redirect message storage unit 142 may be omitted from structural elements of the mobile terminal 100. When a redirect message storing path is included in profile information stored in the profile information storage unit 141, the redirect message storage unit 142 should always be included as a structural element of the mobile terminal 100. When the redirect message storing path is not included in the profile information, the redirect message storage unit 142 may be omitted from the structural elements of the mobile terminal 100.

The input unit 150 receives a key operation signal of a user for controlling the mobile terminal 100 and transfers the received key operation signal to the controller 170. The input unit 150 may be configured as a key pad such as a 3*4 pad or a QWERTY pad including numeral keys, character keys, and arrow keys or a touch panel. The input unit 150 may also be configured as a button key, a jog key, and a wheel key. The input unit 150 generates and transfers an input signal executing applications (call function, music playing function, moving image playing function, image display function, camera photographing function, or Digital Multimedia Broadcasting (DMB) output function) of the mobile terminal according to user input.

The display unit 160 may be configured as a Liquid Crystal Display (LCD), an Organic Light Emitting Diode (OLED), or an Active Matrix Organic Light Emitting Diode (AMOLED). The display unit 160 visibly provides a menu of the mobile terminal 100, input data, function setting information, and other information to a user. The display unit 160 outputs a booting screen, an idle screen, a menu screen, a call screen, and other application screens of the mobile terminal 100. The display unit 160 displays information indicating whether a currently accessed AP 200 is an Internet accessible AP. Before the mobile terminal 100 logs in to the AP 200, when the service limit condition is included in the profile information of the AP 200, the display unit 160 displays a message to prompt the user to log in to the AP 200. The message may include information about a service limit condition.

The controller 170 controls overall operations of the mobile terminal 100. The controller 170 accesses the AP 200 through the near distance communication module 130. The controller 170 determines whether information of the AP 200 is stored as profile information in the profile information storage unit 141. If it is determined that the information of the AP 200 is stored as profile information in the profile information storage unit 141, the controller 170 determines whether a credential is included in the profile information of the AP 200. If it is determined that the credential is included in the profile information, the controller 170 determines the AP 200 as a public AP. If the AP 200 is the public AP, the controller 170 determines whether a service limit condition is set in the profile information.

If it is determined that the service limit condition is not set in the profile information, the controller 170 logs in to the AP 200 using the profile information of the AP 200. If it is determined that the service limit condition is set in the profile information, the controller 170 controls the display unit 160 to display a message selecting presence of execution of logging in. When the user has requested to log in to the AP 200, the controller 170 logs in to the AP 200 using the profile information of the AP 200. When the user does not request login, the controller 170 maintains a current AP connection state.

If the currently accessed AP 200 is not the public AP, the controller 170 determines that the AP 200 is a general AP, and controls the display unit 160 to display information regarding Internet availability.

If the profile information of the AP 200 is not stored in the profile information storage unit 141, the controller 170 controls the near distance communication module 130 to transmit an HTTP request to the AP 200. If a redirect message is received from the AP 200 through the near distance communication module 130, the controller 170 controls the display unit 160 to display the received redirect message. When the credential is received from the user through the input unit 150, the controller 170 logs in using the received credential.

Upon transmitting the HTTP request to the AP 200 through the near distance communication module 130, when the redirect message is not received from the AP 200, the controller 170 determines that the AP 200 is a general AP, and maintains a current AP access state. In this case, the controller 170 analyzes an HTTP response received from the AP 200. When an HTTP response of ‘2xx’ is received from the AP 200, the controller 170 determines that the AP is an Internet accessible AP. When an HTTP response of ‘4xx’ or ‘5xx’ is received from the AP 200, the controller 170 determines that the AP is not an Internet accessible AP. The controller 170 stores information about Internet availability as the profile information of the AP 200.

An explanation of a method for controlling access to an AP in a mobile terminal 100 according to an exemplary embodiment of the present invention is described below.

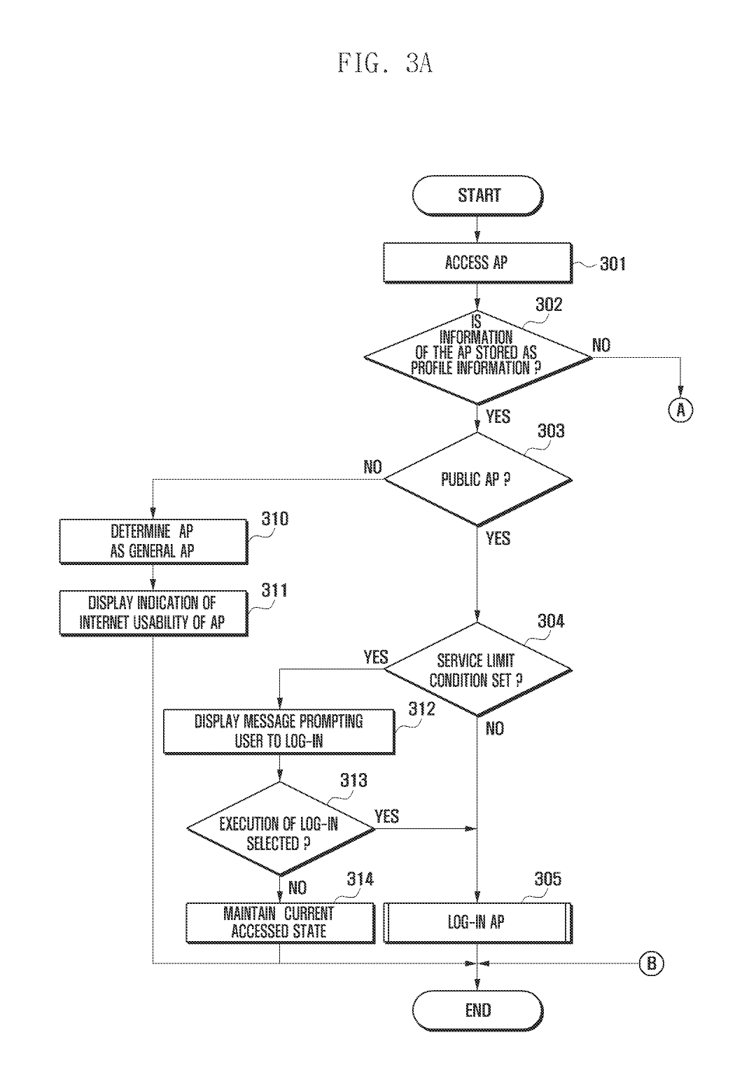

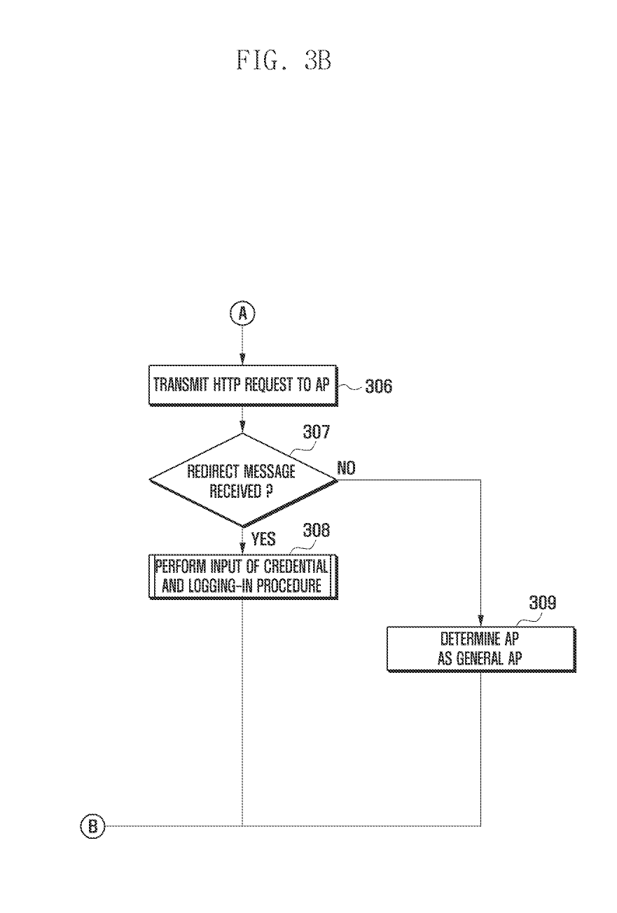

FIG. 3A and FIG. 3B are a flowchart illustrating a method for controlling access to an AP in a mobile terminal according to an exemplary embodiment of the present invention.

Referring to FIGS. 3A and 3B, the controller 170 accesses an AP 200 through a near distance communication module 130 in step 301. The controller 170 performs scanning through the near distance communication module 130 to search APs around the mobile terminal 100. If the AP 200 is selected by a user, the controller 170 accesses the AP 200.

The controller 170 controls the near distance communication module 130 to transmit an access request to the AP 200, and receives an access response to access the AP 200.

The controller 170 determines whether information of the AP 200 is stored in a profile information storage unit 141 as profile information in step 302. The controller 170 determines whether a currently accessed AP 200 has been accessed previously. When the currently accessed AP 200 has been accessed previously, information regarding the AP 200 is stored in the profile information storage unit 141 as profile information.

The profile information may contain an ‘MAC address’, ‘Internet availability’, a ‘credential’, and ‘service limit condition’ of the AP 200. The controller 170 determines whether an MAC address of the AP 200 is stored as the profile information in step 302.

If the information of the AP 200 is stored as the profile information, the controller 170 determines whether the AP 200 is a public AP in step 303. If the mobile terminal 100 logs in to a general AP, a credential corresponding to unique user information is not required. However, to log in to the public AP, the mobile terminal 100 may need the credential. Accordingly, the controller 170 may determine whether the AP 200 is the public AP by determining whether the credential is included in the profile information of the AP 200. If the credential is not included in the profile information of the AP 200, the controller 170 determines that the AP 200 is not the public AP.

If the AP 200 is the public AP, the controller 170 determines whether a service limit condition with respect to use of the AP 200 is set in step 304. When the use of the AP 200 is charged, a time limit condition or a data capacity limit condition may be set as the service limit condition. When a user does not use the Internet, to prevent accounting by a service provider server 400, the controller 170 determines whether the service limit condition is set in the AP 200 in step 304. The controller 170 uses the profile information of the AP 200 to determine whether the service limit condition is set.

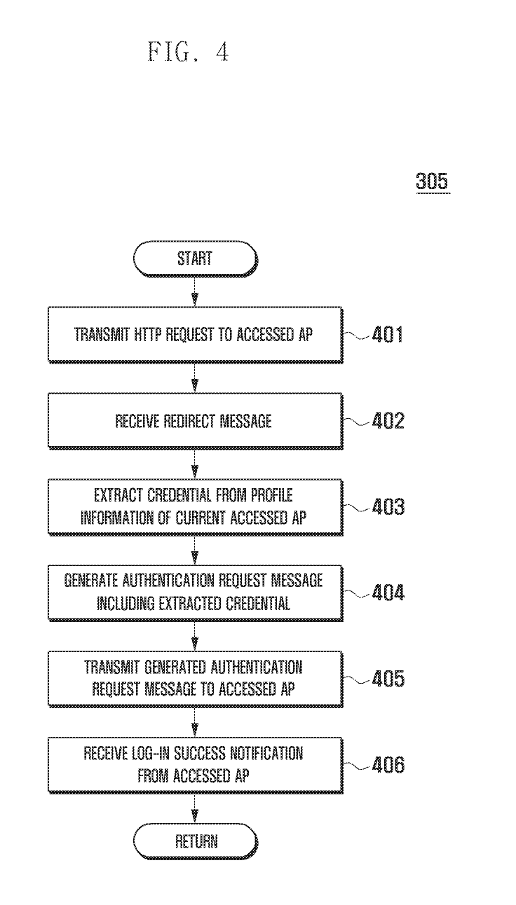

If the service limit condition is not set, the controller 170 logs in to the AP 200 using the profile information of the AP 200 in step 305. The controller 170 extracts a credential from the profile information of the AP 200, and inputs the extracted credential in a redirect message to generate and transmit an authentication request message to the AP 200 in step 305. A detailed procedure of step 350 is described below with reference to FIG. 4.

If the information of the AP 200 is not stored as the profile information, the controller 170 controls a near distance communication module 130 to transmit an HTTP request to the AP 200 in step 306. The controller 170 determines that the AP 200 is accessed for the first time, and logs in to the AP 200 to transmit an HTTP request to the AP 200.

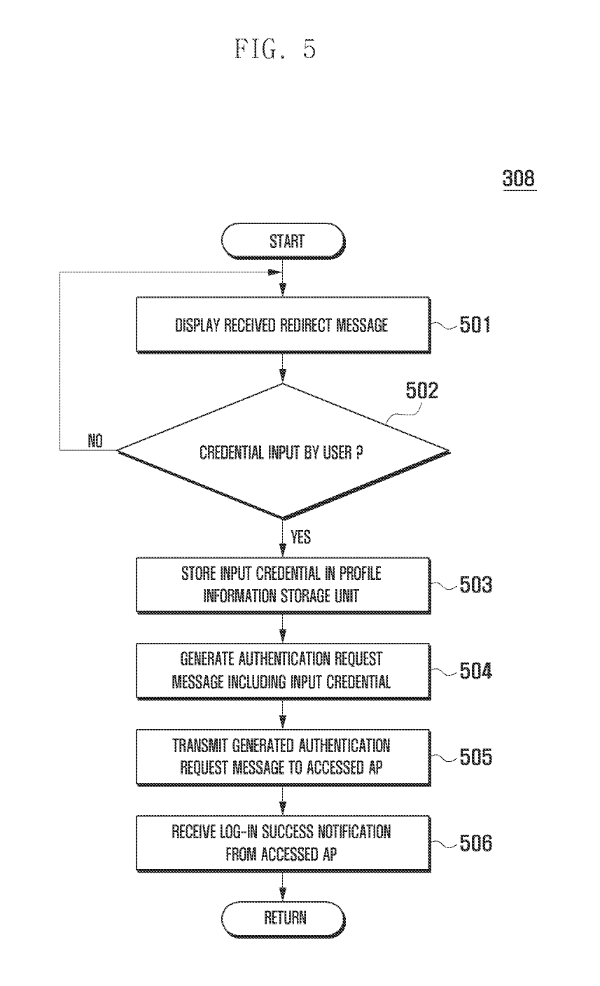

The controller 170 determines whether a redirect message is received from the AP 200 through the near distance communication module 130 in step 307. The redirect message is provided to input the credential upon logging in to the public AP. If the redirect message is received from the AP 200 at step 307, the controller 170 determines that the AP is the public AP and inputs the credential and login procedure in step 308. The credential input by a user at step 308 is stored in the memory 141. Step 308 is described below with reference to FIG. 5.

If the redirect message is not received from the AP 200 at step 307, the controller 170 determines that the AP 200 is the general AP and maintains an accessed state of the currently accessed AP 200 in step 309. When the AP 200 is the general AP, the controller 170 receives an HTTP response to the HTTP request instead of the redirect message through the near distance communication module 130. When an HTTP response of ‘2xx’, such as ‘200’, is received from the AP 200, the controller 170 determines that the AP 200 is an Internet accessible AP and stores this as the profile information. When an HTTP response of ‘4xx’ or ‘5xx’, such as ‘400’ or ‘500’, is received from the AP 200, the controller 170 determines that the AP 200 is not an Internet accessible AP and stores this as the profile information. When the mobile terminal 100 accesses the AP 200, the controller 170 controls the display unit 160 to display an indication of the Internet accessibility of the AP 200, with the result that a user may recognize that the currently accessed AP 200 is an Internet accessible AP based on the displayed presence of the Internet accessibility.

If the currently accessed AP 200 is not the public AP at step 303, the controller 170 determines that the AP is the general AP in step 310, and controls the display unit 160 to display an indication of the Internet accessibility of the AP 200 in step 311. The controller 170 determines Internet availability based on the profile information of the AP 200 stored in the profile information storage unit 141, and displays information regarding Internet availability on the display unit 160.

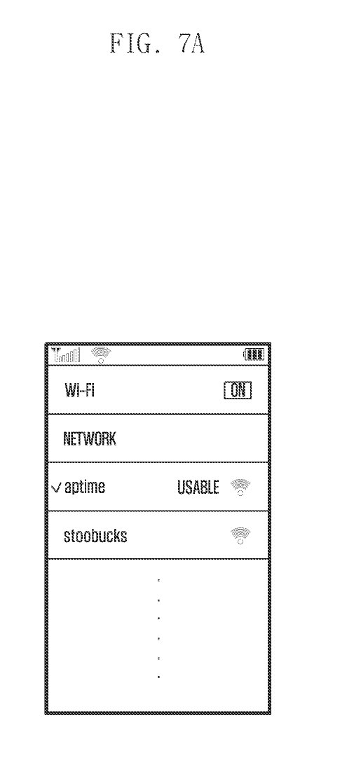

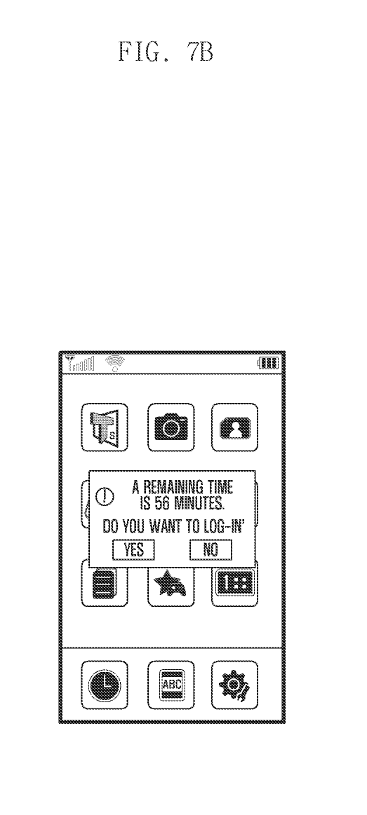

FIGS. 7A and 7B are views illustrating examples of a screen displayed when performing a method for controlling access to an AP in a mobile terminal 100 according to an exemplary embodiment of the present invention. FIG. 7A displays a network name and Internet availability as a Wi-Fi connection set screen. FIG. 7B shows that the mobile terminal 100 presently accesses an AP ‘aptime’, and displays that the AP is an Internet usable AP. A user may recognize that a currently accessed AP is the Internet usable AP based on an upper screen.

Referring to FIGS. 7A and 7B and FIG. 3A, if the service limit condition is set in the profile information of the AP 200 at step 304, the controller 170 controls the display unit 160 in step 312 to display a message prompting the user to log in. The message may contain a remaining time or remaining data amount of the use of the AP 200. The message may contain a message indicating that a fee is charged upon logging in.

FIG. 7B shows a message selecting whether to execute login. FIG. 7B includes selection keys of ‘Yes’ and ‘No’ together with a sentence of ‘a remaining time is 56 minutes. Do you want to log in’ according to an exemplary embodiment of the present invention.

The controller 170 determines whether execution of the login is selected by the user in step 313. The user may select execution of logging in using the input unit 150. Referring to FIG. 7B, the user selects a key ‘Yes’ to execute the login, and selects a key ‘No’ to not execute the login.

When the user requests login, the controller 170 logs in to the AP 200 using profile information of the AP 200 in step 305. When the user does not request login, the controller 170 maintains an accessed state with the currently accessed AP 200 in step 314.

FIG. 4 is a flowchart illustrating a detailed procedure of step 305 shown in FIG. 3A according an exemplary embodiment of the present invention.

Referring to FIG. 4, the controller 170 controls a near distance communication module 130 to transmit an HTTP request to the AP 200 accessed in step 301 of FIG. 3A in step 401. The HTTP request of step 401 is a login request to the AP 200. The HTTP request is transmitted to the AP 200, and the AP 200 transmits the HTTP request to a gateway 130.

The controller 170 receives a redirect message from the AP 200 through a near distance communication module 130 in step 402. Upon execution of login to the AP 200, the redirect message is provided for credential input. When the mobile terminal 100 requests a URL, the redirect message may be a captive portable automatically provided from the AP 200. When roaming from a home entity to a public AP in a Wireless Internet Service Provider Roaming (WISPr), the redirect message may be an authentication screen provided to the mobile terminal 100. If the gateway 130 receives the HTTP request from the AP 200, the redirect message is transmitted to the AP 200, and the AP 200 transmits the redirect message to the mobile terminal 100. Accordingly, the controller 170 receives the redirect message through the near distance communication module 130.

The controller 170 searches a profile information storage unit 141 to extract a credential from profile information of a currently accessed AP 200 in step 403. The controller 170 extracts a user ID and a password stored in the profile information storage unit 141 corresponding to the AP 200. According to an exemplary embodiment of the present invention, the controller 170 determines whether the profile information of the AP 200 is stored at step 302 of FIG. 3A. When the profile information of the AP 200 is stored, the controller 170 may extract a credential from the profile information of the AP 200.

The controller 170 generates an authentication request message including the extracted credential in step 404. The controller 170 inputs the credential extracted at step 430 in the redirect message received at step 402 to generate the authentication request message.

The controller 170 controls the near distance communication module 130 to transmit the generated authentication request message to the currently accessed AP 200 in step 405. The AP 200 transmits the authentication request message to the gateway 130, and the gateway 130 transmits the authentication request message to the service provider server 400.

The controller 170 receives a login Success Notification from the currently accessed AP 200 through the near distance communication module 130 in step 406. The service provider server 400 determines whether a user of the mobile terminal 100 is an authenticated user based on a credential included in the authentication request message. If the user of the mobile terminal 100 is the authenticated user, the service provider server 400 transmits an authentication response message including ‘accept’ information to the gateway 130, and the gateway 130 transmits the login Success Notification to the mobile terminal 100. Accordingly, the controller 170 receives the login Success Notification from the AP 200 through the near distance communication module 130. After receiving the login Success Notification, the controller 170 stores ‘Internet availability’ with respect to the AP 200 in the profile information storage unit 141 as ‘YES’.

A procedure for transmitting an HTTP request to the AP 200, a procedure receiving a redirect message, a procedure for generating and transmitting an authentication request message including a credential to the AP 200 are all performed by background operations. Consequently, although the user does not perform an operation for executing a browser and inputting a user ID and a password, exemplary embodiments of the present invention may provide an Internet use environment to the user.

FIG. 5 is a flowchart illustrating a detailed procedure of step 308 shown in FIG. 3B according an exemplary embodiment of the present invention.

Referring to FIG. 5, the controller 170 controls a display unit 160 to display a redirect message received at step 307 of FIG. 3B in step 501. The redirect message includes a window that allows the user to input a credential such as a user ID and a password. The controller 170 determines whether credential input by a user occurs through an input unit 150 in step 502. When the user inputs a previously registered user ID and password for use of the AP 200 while viewing a redirect message displayed on the display unit 160, the controller 170 recognizes the user ID and the password input by the user through the input init 150.

The controller 170 stores a credential input by a user in the profile information storage unit 141 in step 503. The controller 170 stores the credential input at step 502 as profile information corresponding to the currently accessed AP 200. The controller 170 stores a MAC address of the AP 200, a credential, and a service limit condition in the profile information storage unit 141. Because the public AP is an Internet accessible AP, the controller 170 may store ‘YES’ as information regarding ‘Internet availability’.

The controller 170 generates an authentication request message including the credential input at step 502 in step 504. The controller 170 inputs the credential input at step 502 in the redirect message received at step 307 of FIG. 3B to generate the authentication request message.

The controller 170 controls the near distance communication module 130 to transmit the generated authentication request message to the currently accessed AP 200 in step 505. The AP 200 transmits the authentication request message to the gateway 130, and the gateway 130 transmits the authentication request message to the service provider server 400.

The controller 170 receives a login Success Notification from the currently accessed AP 200 through the near distance communication module 130 in step 506. The service provider server 400 determines whether a user of the mobile terminal 100 is an authenticated user based on a credential included in the authentication request message. If the user of the mobile terminal 100 is the authenticated user, the service provider server 400 transmits an authentication response message including ‘accept’ information to the gateway 130, and the gateway 130 transmits the login Success Notification to the mobile terminal 100. Accordingly, the controller 170 receives the login Success Notification from the AP 200 through the near distance communication module 130.

When the mobile terminal 100 accesses the same AP 200 later, the profile information stored at step 308 is used to enable the mobile terminal 100 to automatically log in to the AP 200.

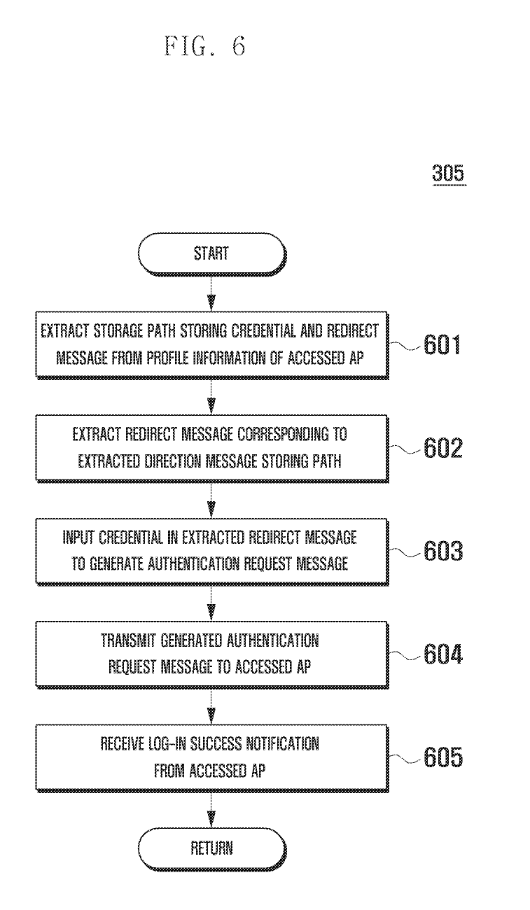

FIG. 6 is a flowchart illustrating a detailed procedure of step 305 shown in FIG. 3A according to another exemplary embodiment of the present invention. FIG. 6 illustrates the procedure of step 305 performed using a mobile terminal 100 including a memory 140 having a redirect message storage unit 142 of FIG. 2.

Referring to FIG. 6, the controller 170 stores the credential input by a user at step 308 of FIG. 3B in the profile information storage unit 141 and simultaneously stores the redirect message received from the AP 200 in the redirect message storage unit 142. The controller 170 controls the display unit 160 to display a redirect message and simultaneously stores the received redirect message in the redirect message storage unit 142 in step 501 of FIG. 5. The controller 170 stores the credential input by the user in the profile information storage unit 141 together a storage path storing the redirect message in step 503 of FIG. 5.

The controller 170 extracts a storage path storing a credential and a corresponding redirect message from profile information of the currently accessed AP 200 in step 601. As shown in FIG. 6, the profile information further contains not only an ‘MAC address’, ‘Internet availability’, a ‘credential’, and ‘service limit condition’, but also a ‘redirect message storing path’.

In comparison with step 403 of FIG. 4, the controller 170 additionally extracts a redirect message storing path from the profile information of the AP 200. When a redirect message having the credential is stored in the redirect message storage unit 142, the controller 170 may extract only a redirect message storing path of the currently accessed AP 200 without extracting the credential from the profile information in step 601.

The controller 170 extracts a redirect message corresponding to the extracted direction message storing path from the redirect message storage unit 142 in step 602. The controller 170 inputs a credential in the extracted redirect message to generate an authentication request message in step 603. According to an exemplary embodiment of the present invention, when the credential is previously input in the redirect message, the controller 170 may generate the redirect message extracted at step 602 as the authentication request message.

The controller 170 controls the near distance communication module 130 to transmit the generated authentication request message to the currently accessed AP 200 in step 604. The AP 200 transmits the authentication request message to the gateway 130, and then the gateway 130 transmits the authentication request message to the service provider server 400.

The controller 170 receives a login Success Notification from the currently accessed AP 200 through the near distance communication module 130 in step 605. The service provider server 400 determines whether a user of the mobile terminal 100 is an authenticated user based on a credential included in the authentication request message. If the user of the mobile terminal 100 is the authenticated user, the service provider server 400 transmits an authentication response message including ‘accept’ information to the gateway 130, and then the gateway 130 transmits the login Success Notification to the mobile terminal 100. Accordingly, the controller 170 receives the login Success Notification from the AP 200 through the near distance communication module 130.

Since the exemplary embodiment shown in FIG. 6 stores a redirect message received from the AP 200 with respect to a first accessed AP 200, and uses the previously stored redirect message when logging in to the same AP 200 later, it is unnecessary to transmit an HTTP request to the AP 200. As a result, the mobile terminal 100 may rapidly log in to the AP 200.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for controlling access to an Access Point (AP) in a mobile terminal, the method comprising:
storing information of an AP as profile information;
determining whether profile information of an accessed AP is stored in the mobile terminal when the mobile terminal accesses the AP; and
logging in to the accessed AP based on the stored profile information.

2. The method of claim 1, wherein the storing of the information of the AP comprises storing at least one of a Media Access Control (MAC) address, unique user information, Internet availability, and service limit information of the accessed AP as the profile information.

3. The method of claim 2, wherein the determining of whether the profile information of the accessed AP is stored in the mobile terminal comprises determining whether a MAC address of the accessed AP is stored as the profile information.

4. The method of claim 3, further comprising:
determining whether unique user information is included in the stored profile information corresponding to the accessed AP; and
determining that the accessed AP is a public AP when the unique user information is included in the stored profile information, and determining that the accessed AP is a general AP when the unique user information is not included in the stored profile information.

5. The method of claim 1, further comprising:
transmitting a HyperText Transfer Protocol (HTTP) request to the accessed AP when the profile information of the accessed AP is not stored in the mobile terminal;
receiving a redirect message from the accessed AP;
displaying the received redirect message;
storing input unique user information in the profile information when the unique user information is input to the redirect message;
generating an authentication request message including the input unique user information;
transmitting the generated authentication request message to the accessed AP; and
receiving a login success notification from the accessed AP.

6. The method of claim 5, further comprising:
determining that the accessed AP is a general AP when a redirect message is not received from the AP; and
maintaining an access state with the accessed AP.

7. The method of claim 4, wherein the logging in to the accessed AP comprises:
determining whether service limit condition information is included in the profile information when the accessed AP is the public AP;
transmitting an HTTP request to the accessed AP when the service limit condition information is not included in the profile information;
receiving a redirect message from the accessed AP;
extracting unique user information from the profile information of the accessed AP;
generating an authentication request message including the extracted unique user information;
transmitting the generated authentication request message to the accessed AP; and
receiving a login success notification from the accessed AP.

8. The method of claim 7, wherein the logging in to the accessed AP comprises:
displaying a message prompting a user to log in when the service limit condition information is included in the profile information;
transmitting an HTTP request to the accessed AP when the login is performed by the user, and maintaining an access state of the accessed AP when the login is not performed by the user.

9. The method of claim 4, further comprising:
determining Internet availability of the accessed AP based on the profile information of the AP when the accessed AP is the general AP; and
displaying information regarding Internet availability of the accessed AP.

10. The method of claim 1, wherein the storing of the information of the AP comprises:
storing a redirect message received from the accessed AP; and
storing at least one of a Media Access Control (MAC) address, unique user information, Internet availability, and service limit information of the accessed AP as the profile information.

11. The method of claim 10, wherein the logging in to the accessed AP comprises:
extracting a storing path of unique user information and a redirect message from the profile information of the accessed AP;
extracting the redirect message corresponding to the extracted storing path;
inputting the unique user information in the extracted redirect message to generate an authentication request message;
transmitting the generated authentication request message to the accessed AP; and
receiving a login success notification from the accessed AP.

12. A mobile terminal comprising:
a memory for storing profile information of at least one Access Point (AP);
a near distance communication module for accessing an AP; and
a controller for determining whether the profile information of the accessed AP is stored in the memory, and for logging in to the accessed AP based on the stored profile information when the profile information of the accessed AP is stored in the memory.

13. The mobile terminal of claim 12, wherein the memory stores at least one of a Media Access Control (MAC) address, unique user information, Internet availability, and service limit information of the accessed AP as the profile information.

14. The mobile terminal of claim 13, wherein the controller determines whether unique user information is included in stored profile information corresponding to the accessed AP, and
the controller determines that the accessed AP is a public AP when the unique user information is included in the stored profile information, and determines that the accessed AP is a general AP when the unique user information is not included in the stored profile information.

15. The mobile terminal of claim 14, wherein the controller determines whether service limit condition information is included in the profile information when the accessed AP is the public AP upon logging in, transmits a HyperText Transfer Protocol (HTTP) request to the accessed AP when the service limit condition information is not included in the profile information, extracts unique user information from the profile information of the accessed AP when a redirect message is received from the accessed AP, generates an authentication request message including the extracted unique user information, transmits the generated authentication request message to the accessed AP through the near distance communication module, and receives a login success notification from the accessed AP.

16. The mobile terminal of claim 14, further comprising a display unit for displaying information regarding Internet availability of the accessed AP stored as the profile information when the controller determines that the accessed AP is the general AP.

17. The mobile terminal of claim 13, wherein the memory comprises:
a redirect message storage unit for storing a redirect message received from the accessed AP; and
a profile information storage unit for storing at least one of a Media Access Control (MAC) address, unique user information, Internet availability, or service limit information of the accessed AP as the profile information.

18. The mobile terminal of claim 17, wherein the controller extracts a storing path of unique user information and a redirect message from the profile information of the accessed AP, extracts a redirect message corresponding to the extracted storing path, inputs the unique user information in the extracted redirect message to generate an authentication request message, transmits the generated authentication request message to the accessed AP through the near distance communication module, and receives a login success notification from the accessed AP.
